(19) United States
(12) Patent Application Publication
(10) Pub. No.: US 2012/0047818 A1
(43) Pub. Date: Mar. 1, 2012

(54) ROOFING GUTTER INSERT

(76) Inventor: Netza Lopez, Canton, GA (US)

(21) Appl. No.: 13/197,816

(22) Filed: Aug. 4, 2011

Related U.S. Application Data
(60) Provisional application No. 61/371,378, filed on Aug. 6, 2010.

(51) Int. Cl. E04D 13/076; B28B 1/48

(52) U.S. Cl. 52/12; 264/154

(57) ABSTRACT

A gutter insert for a roofing gutter is provided. The roofing gutter has a rear wall, a bottom wall and a front wall. The gutter insert includes a body having a generally triangular cross-sectional shape formed from a top face, a back face and a diagonal face. The diagonal face forms a diagonal from one end of the top face to one end of the back face. A plurality of cutouts originate in the diagonal face and extend into the body. A void is defined by the diagonal face of the body of the gutter insert and the interior surfaces of the bottom wall and front wall of the roofing gutter. The cutouts and the void are configured to facilitate the flow of rain water through the roofing gutter.

### RELATED APPLICATIONS

This application claims the benefit of pending U.S. Provisional Patent Application No. 61/371,378, filed Aug. 6, 2010, the disclosure of which is incorporated herein by reference.

### BACKGROUND

Buildings, such as for example, commercial and residential buildings, can have rain gutters positioned at the lower edges of the building roof. The rain gutters are configured to catch rain water flowing from the roof and provide a conduit for the rain water to flow to downspouts. In some instances, the gutters can become clogged with debris, including leaves and twigs. When gutters become sufficiently clogged, the rain water flowing from the roof cannot be received by the gutters and the gutters cannot direct the rain water to the downspouts. As a result, the rain water can spill over the gutters.

Gutters can be provided with gutter inserts configured for reducing or preventing the influx of debris into the gutter. It would be advantageous if the gutter inserts could be improved.

### SUMMARY

In accordance with embodiments of this invention there is provided a gutter insert for a roofing gutter. The roofing gutter has a rear wall, a bottom wall and a front wall. The gutter insert includes a body having a generally triangular cross-sectional shape formed from a top face, a back face and a diagonal face. The diagonal face forms a diagonal from one end of the top face to one end of the back face. A plurality of cutouts originates in the diagonal face and extends into the body. A void is defined by the diagonal face of the body of the gutter insert and the interior surfaces of the bottom wall and front wall of the roofing gutter. The cutouts and the void are configured to facilitate the flow of rain water through the roofing gutter.

In accordance with embodiments of this invention there are also provided a method of forming a gutter insert for a roofing gutter, the roofing gutter having a rear wall, a bottom wall and a front wall. The method includes the steps of forming a body having a generally triangular cross-sectional shape formed from a top face, a back face and a diagonal face, the diagonal face forming a diagonal from one end of the top face to one end of the back face and forming a plurality of cutouts in the body, wherein the plurality of cutouts originate in the diagonal face of the body and extend into the body. The diagonal formed by the diagonal face of the body defines a void between the diagonal face and the interior surfaces of the bottom wall and front wall of the roofing gutter. The cutouts and the void are configured to facilitate the flow of rain water through the roofing gutter.

Various advantages of this invention will become apparent to those skilled in the art from the following detailed description of the invention, when read in light of the accompanying drawing.

### BRIEF DESCRIPTION OF THE DRAWINGS

FIG. 1 is a perspective view of a gutter insert illustrating a plurality of parabolically-shaped cutouts.

FIG. 2 is a front view, in elevation, of the gutter insert of FIG. 1.

FIG. 3 is an end view, in elevation, of the gutter insert of FIG. 1 installed in a gutter.

FIG. 4A is a perspective view of a second embodiment of a gutter insert.

FIG. 4B is an end view, in elevation, of the gutter insert of FIG. 4A.

FIG. 5A is a perspective view of a third embodiment of a gutter insert.

FIG. 5B is an end view, in elevation, of the gutter insert of FIG. 5A.

FIG. 6A is a perspective view of a fourth embodiment of a gutter insert.

FIG. 6B is an end view, in elevation, of the gutter insert of FIG. 6A.

FIG. 7A is a perspective view of a fifth embodiment of a gutter insert.

FIG. 7B is an end view, in elevation, of the gutter insert of FIG. 7A.

FIG. 8A is a perspective view of a sixth embodiment of a gutter insert.

FIG. 8B is an end view, in elevation, of the gutter insert of FIG. 8A.

FIG. 9A is a perspective view of a seventh embodiment of a gutter insert.

FIG. 9B is an end view, in elevation, of the gutter insert of FIG. 9A.

### DETAILED DESCRIPTION OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

The description and figures disclose gutter inserts configured for placement within roofing gutters. The term “roofing gutter”, as used herein, is defined to mean a trough that channels water from the building eaves to the downspouts. The term “insert”, as used herein, is defined to mean a body or structure placed within a gutter. The term “debris”, as used herein, is defined to mean any materials, such as the non-limiting examples of leaves, twigs, dirt, pine needles, or portions of shingles entering the roofing gutter. The term “cutout”, as used herein, is defined to mean a shape formed within the gutter insert to facilitate the flow of rain water through the gutter insert.

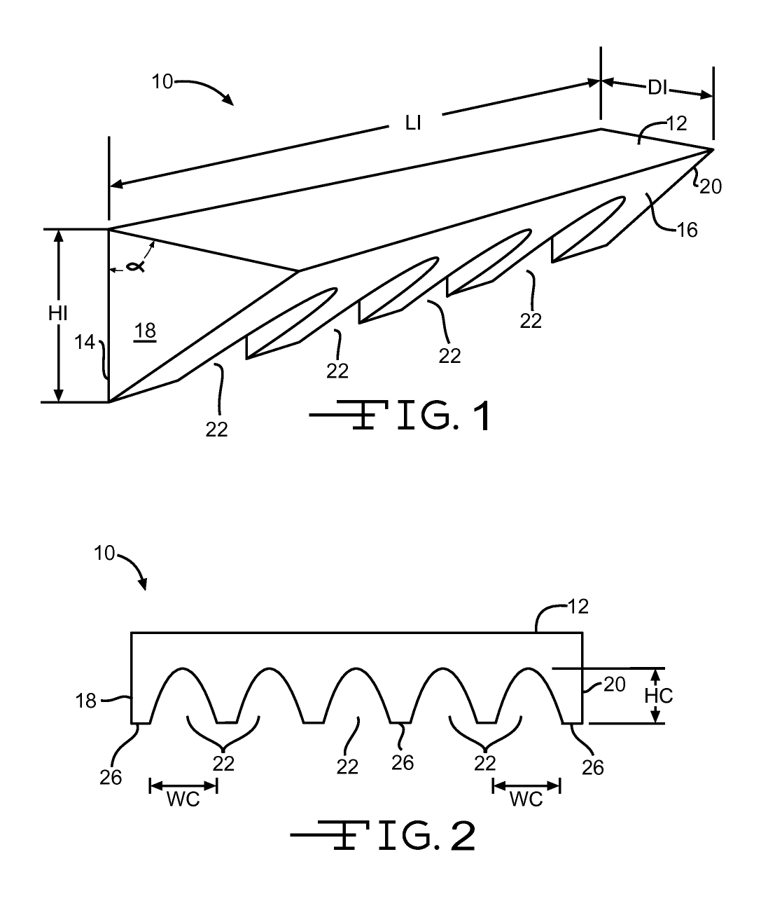

Referring now to FIG. 1, a first embodiment of a gutter insert is shown generally at 10. The gutter insert 10 is configured for placement within a roofing gutter and further configured to prevent or substantially retard the influx of debris flowing into the roofing gutter.

The gutter insert 10 includes a body having a top face 12, a back face 14, a diagonal face 16, and end faces, 18 and 20. The top face 12 and the back face 14 cooperate to form an angle α. As shown in FIG. 3, the angle α provides that the back face 14 of the gutter insert 10 seats substantially flush against a portion of a roofing gutter 40 while the top face 12 forms a substantially horizontal surface within the roofing gutter 40. In the illustrated embodiment, the angle α is approximately 90°. Alternatively, the angle α can be more or less than approximately 90°.

Referring again to FIG. 1, the diagonal face 16 of the gutter insert 10 is positioned to be opposite of the angle α and forms a diagonal surface extending from one end of the top face 12 to one end of the back face 14. As will be explained in more detail below, the exterior surface of the diagonal face 16 cooperates with various interior surfaces of the roofing gutter 40 to form a void within the roofing gutter 40.

The diagonal face 16 includes a plurality of spaced apart cutouts 22. In the illustrated embodiment, the cutouts 22 originate from the diagonal face 16 and extend in a generally horizontal direction from the diagonal face 16 of the gutter insert 10 to the back face 14 of the gutter insert 10. However, in other embodiments, the cutouts 22 can extend any desired distance from the diagonal face 16 of the gutter insert 10 in a generally horizontal direction into the body of the gutter insert 10.

The gutter insert 10 has a length LI, a height HI and a depth DI. The height HI and depth DI of the gutter insert 10 are configured to result in a cross-sectional shape of the gutter insert 10 that spans an internal width and an internal height of the roofing gutter 40. Referring now to FIG. 3, the width WG and the height HG of roofing gutters 40 can vary based on the adjoining area of the roof that they drain. Accordingly the dimensions LI, HI and DI of the roofing insert 10 will vary based on the width WG and the height HG of the roofing gutter 40. As one example, a common “K-style” residential roofing gutter (designated as a size “5K”) has a height HG of 3.6 inches and a width WG of 3.6 inches. The resulting gutter insert 10 to accommodate this size roofing gutter would have a height HI of approximately 3.5 inches and a depth DI of approximately 4.1 inches. As another example, another common “K-style” commercial roofing gutter (designated as a size “6K”) has a height HG of 4.6 inches and a width WG of 4.6 inches. The resulting gutter insert 10 to accommodate this size roofing gutter would have a height HI of approximately 4.5 inches and a depth DI of approximately 5.1 inches.

Referring again to embodiment illustrated in FIG. 1, the length LI of the gutter insert 10 is approximately 48 inches. Alternatively, the length LI of the gutter insert 10 can be more or less than approximately 48 inches.

Referring again to FIG. 1, the gutter insert 10 is formed from an open cell polymeric foam. The open cell structure of the gutter insert 10 is configured to permit rainwater flowing into the roofing gutter 10, to pass through the gutter insert 10, but prevent or substantially retard debris from entering the roofing gutter 10. In the illustrated embodiment, the gutter inserts 10 are formed with a polymeric foam having a pore size in a range of from about 5 pores per inch (ppi) to about 14 ppi. However, in other embodiments, the polymeric foam can have a pore size less than about 5 pores per inch (ppi) or more than about 14 ppi.

The open cell polymeric foam material forming the gutter insert 10 has a density. In the illustrated embodiment, the density is in a range of from about 1.4 lb/ft³ to about 1.8 lb/ft³. In other embodiments, the density of the open cell polymeric foam material can be less than about 1.4 lb/ft³ or more than about 1.8 lb/ft³.

The open cell polymeric foam material forming the gutter insert 10 has a tensile strength. In the illustrated embodiment, the tensile strength is in a range of from about 5.0 pounds per square inch (hereafter psi) to about 8.0 psi. In other embodiments, the tensile strength of the open cell polymeric foam material can be less than about 5.0 psi or more than about 8.0 psi.

Referring again to the embodiment illustrated in FIG. 1, the gutter insert 10 meets flammability standards as provided by ASTM D2859. ASTM D2859 provides standard test methods for ignition characteristics of finished textile floor covering materials. The acceptance criterion of these standards requires that at least seven out of eight individual specimens of a given carpet or rug have passed the test, that is, the charred portion of a tested specimen shall not extend to within 25.4 mm [1.0 in.] of the edge of the hole in the flattening frame at any point.

As described above, the gutter insert 10 is formed from a polymeric foam. The polymeric foam is configured to be substantially weather resistant and maintain its general triangular cross-sectional shape regardless of the temperature, weather conditions or the weight of ice or rainwater acting on the gutter insert 10. In the illustrated embodiment, the polymeric foam is polyurethane-based material. In other embodiments, the polymeric foam can be made from other suitable open cell materials, including the non-limiting examples of polystyrene, polypropylene and polyethylene. In still other embodiments, the gutter insert 10 can be made from a non-woven material made up of a plurality of randomly oriented and interconnected fibers or filaments, such as the non-limiting example of glass fibers, thermoset fibers, thermoplastic fibers or webs formed from metallic fibers.

Referring again to FIG. 1, the gutter insert 10 can include materials or coatings to impart desired characteristics to the gutter insert 10. As one non-limiting example, the gutter insert 10 can include algicidal materials or coatings configured to inhibit the growth of the microorganisms including algae and/or fungi. As another non-limiting example, the gutter insert 10 can include fire retardant materials or coatings configured to retard or suppress the spread of flames. In yet another non-limiting example, the gutter insert 10 can include ultra-violet light inhibitors. In still other embodiments, the gutter insert 10 can include desired combinations of materials and/or coatings.

Referring now to FIG. 2, the gutter insert 10 having the plurality of spaced apart cutouts 22 is illustrated. In the embodiment illustrated in FIG. 2, the cutouts 22 have a parabolic shape, with the vertex of the parabola positioned closer to the top face 12 and the parabola opening in a direction toward a bottom edge 26 of the gutter insert 10. The term “parabolic-shape”, as used herein, is defined to mean a two-dimensional shape formed by the intersection of a plane and a cone. The parabolic shape of the cutouts 22 is configured to facilitate several benefits to the gutter insert 10, although all benefits may not be present in all instances. First, by reducing the amount of material through which the rainwater flows and increasing the surface area of the cutouts 22, the cutouts 22 are configured to optimize the flow of rainwater through the gutter insert 10. Second, the parabolic shape of the cutouts 22 permits the gutter insert 10 to maintain structural integrity (e.g. resist buckling) despite the elimination of material.

While the illustrated embodiment shows the cutouts 22 as having a parabolic shape, it should be appreciated that the cutouts 22 can have other desired shapes, such as the non-limiting examples of a rectangular, arcuate or saw tooth shape.

Referring again to FIG. 2, the cutouts 22 have a width WC and a height HC. In the illustrated embodiment the width WC is in a range of from about 1.5 inches to about 5.0 inches and the height HC is in a range of from about ⅓ to about ¾ of the height HI of the gutter insert 10. In other embodiments, the width WC can be less than about 1.5 inches or more than about 5.0 inches and the height HC can be less than about ⅓ or more than about ¾ of the height HI of the gutter insert 10.

While the embodiment illustrated in FIG. 2 shows a quantity of five cutouts 22 equally spaced apart, it should be understood that the gutter insert 10 can have any desired number of cutouts 22 and that the cutouts 22 can have different spacing therebetween. Additionally, while the embodiment illustrated in FIG. 2 shows all of the cutouts 22 as having the same height HC and width WC, it should be appreciated that in other embodiments the cutouts 22 can have different heights HC and different widths WC.

Referring now to FIG. 3, a gutter insert 10 is shown in an installed position within a roofing gutter 40. The roofing gutter 40 is positioned on a building under an eave or overhang of a roof 42. The roofing gutter 40 may be held in place by a plurality of fasteners (not shown); such as for example nails configured to affix the roofing gutter 40 to the building structure 44. The roofing gutter 40 can be any conventional gutter structure having a rear wall 46, a bottom wall 48, and an irregularly shaped front wall 50. The front wall 50 can have an inwardly projecting lip 52.

As discussed above, the gutter insert 10 is sized such that the top face 12 extends from the lip 52 of the roofing gutter 40 to the rear wall 46 of the roofing gutter 40. As shown in FIG. 3, the top face 12 of the gutter insert 10 is positioned under the lip 52 of the roofing gutter 40, the back face 14 of the gutter insert is seated against the rear wall 46 of the roofing gutter 40 and the intersection of the back face 14 and the diagonal face 16 of the gutter insert 10 is seated against the intersection of the rear wall 46 and bottom wall 48 of the roofing gutter 40.

Referring again to FIG. 3, the diagonal face 16 of the gutter insert 10 cooperates with the interior surface of the front wall 50 of the roofing gutter 40 and the interior surface of the bottom wall 48 of the roofing gutter 40 to define void V. The void V is configured to facilitate the flow of water along the bottom wall 48 of the roofing gutter 40.

The gutter inserts 10 are installed in the roofing gutter 40 by placing a sufficient quantity of gutter inserts 10 in an end-to-end relationship along a length of the roofing gutter 40 to provide complete coverage of the roofing gutter 40. As discussed above, the gutter insert 10 has a length LI of approximately 48.0 inches. The length LI facilitates installation of the gutter inserts 10 by a single person. Additionally, the gutter inserts 10 may be easily cut to a desired length, so as to fill a space that is less than 48.0 inches between the last installed gutter insert 10 and an end (not shown) of the roofing gutter 40.

Additionally, the gutter inserts 10 can be quickly and easily installed in the roofing gutters 40 without the need for any specialized tools or fastening mechanisms, such as for example, clips, spikes or adhesives. The gutter insert 10 is securely held in place by the positioning of the gutter insert 10 within the roofing gutter 40 as shown in FIG. 3.

In operation, rain water flowing from the roof 42 flows into the roofing gutter 40. Once in the roofing gutter 40, the rain water flows through the gutter insert 10 to the void V located within the roofing gutter 40 between the diagonal face 16 of the gutter insert 10 and the interior surfaces of the bottom and front walls, 48 and 50. The rain water then flows along the bottom wall 48 of the roofing gutter 40 to one or more downspouts (not shown), where the rain water is discharged. Leaves and other debris that are carried off of the roof 42 by the rain water remain on the top face 12 of the gutter insert 10, as the debris cannot pass through the gutter insert 10. In some instances, the leaves and other debris can be blown off of the top face 12 of the gutter insert 10 by wind. In other instances, the leaves and other debris can deteriorate over time, such as to form small particles or pieces that are able to pass through the gutter insert 10 to the void V located within the roofing gutter 40. The small particles or pieces then can washed away by the rain water flowing along the bottom wall 48 of the roofing gutter 40.

Due to the porous nature of the material of the gutter insert 10, the gutter insert 10 dries quickly. As a result, very little maintenance is required to maintain the gutter insert 10 in a clean and functional condition.

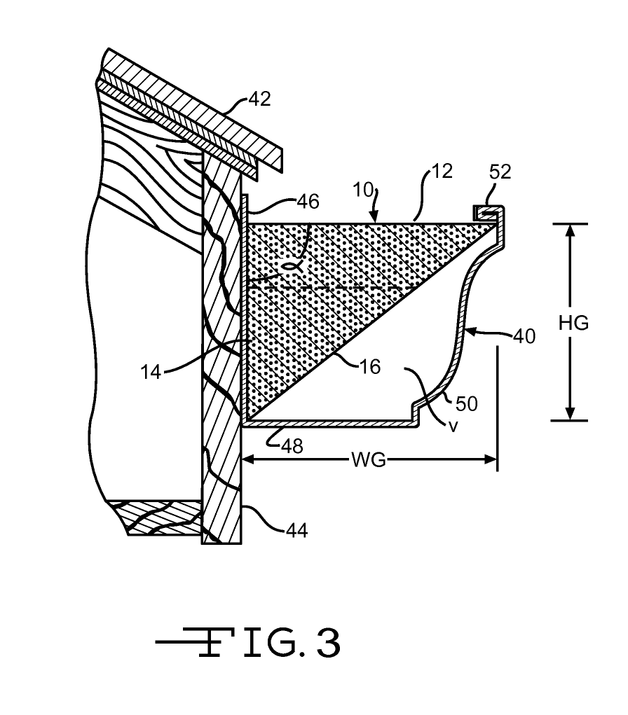

Referring now to FIGS. 4A and 4B, a second embodiment of a gutter insert is shown generally at 110. The gutter insert 110 is generally the same as, or similar to, the gutter insert 10 described above and illustrated in FIGS. 1 and 2 with the exception that cutouts 122 are arranged to be substantially parallel and extending from end face 118 to end face 120 of the gutter insert 110. In a similar manner as described for cutouts 22 discussed above, the cutouts 122 are configured to optimize the flow of rainwater through the gutter insert 110 by reducing the amount of material through which the rainwater flows and further configured to maintain structural integrity (e.g. resist buckling) despite the elimination of material.

While the cutouts 122 illustrated in FIGS. 4A and 4B have an angular cross-sectional shape, it should be appreciated that the cutouts 122 can have other cross-sectional shapes, including circular, parabolic or irregular cross-sectional shapes. While the gutter insert 110 is shown as having a quantity of three cutouts 122, it should be appreciated that in other embodiments the gutter insert 110 can have more or less than three cutouts 122. While the cutouts 122 are shown in FIGS. 4A and 4B as being contiguous, it should be appreciated that alternative embodiments of the gutter insert 110 can arrange the cutouts 122 to be spaced apart.

Referring now to FIGS. 5A and 5B, a third embodiment of a gutter insert is shown generally at 210. The gutter insert 210 is generally the same as, or similar to, the gutter insert 10 described above and illustrated in FIGS. 1 and 2 with the exception that spaced apart cutouts 222 are arranged to be substantially parallel and extending from end face 218 to end face 220 of the gutter insert 210. In a similar manner as described for cutouts 22 discussed above, the cutouts 222 are configured to optimize the flow of rainwater through the gutter insert 210 by reducing the amount of material through which the rainwater flows and further configured to maintain structural integrity (e.g. resist buckling) despite the elimination of material.

While the cutouts 222 illustrated in FIGS. 5A and 5B have a rectangular cross-sectional shape, it should be appreciated that the cutouts 222 can have other cross-sectional shapes, including circular, parabolic or irregular cross-sectional shapes. While the gutter insert 210 is shown as having a quantity of four cutouts 222, it should be appreciated that in other embodiments the gutter insert 210 can have more or less than four cutouts 222. The cutouts 222 can be spaced apart by any desired distance.

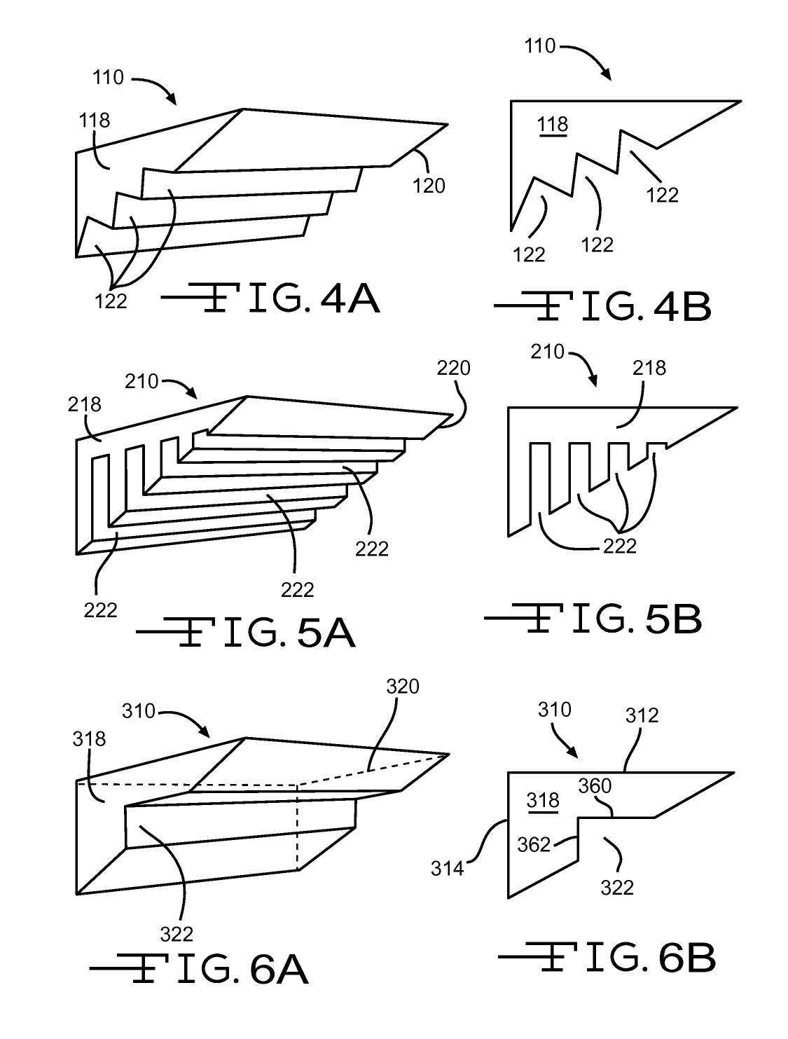

Referring now to FIGS. 6A and 6B, a fourth embodiment of a gutter insert is shown generally at 310. The gutter insert 310 is generally the same as, or similar to, the gutter insert 10 described above and illustrated in FIGS. 1 and 2 with the exception that a cutout 322 extends from end face 318 to end face 320 of the gutter insert 310.

The cutout 322 includes a first side 360 and a second side 362. In the illustrated embodiment, the first side 360 of the cutout 322 is substantially parallel with a top face 312 of the gutter insert 310 and the second side 362 of the cutout 322 is substantially parallel with a back face 314 of the gutter insert 310. Without being bound by the theory, it is believed that the first side 360 of the cutout, being substantially parallel with the top face 312 of the gutter insert 310, optimizes the flow of rainwater through the gutter insert 310 by reducing the amount of material through which the rainwater flows. It is further believed that the second side 362 of the cutout 310 maintains structural integrity of the gutter insert 310 despite the elimination of the cutout material.

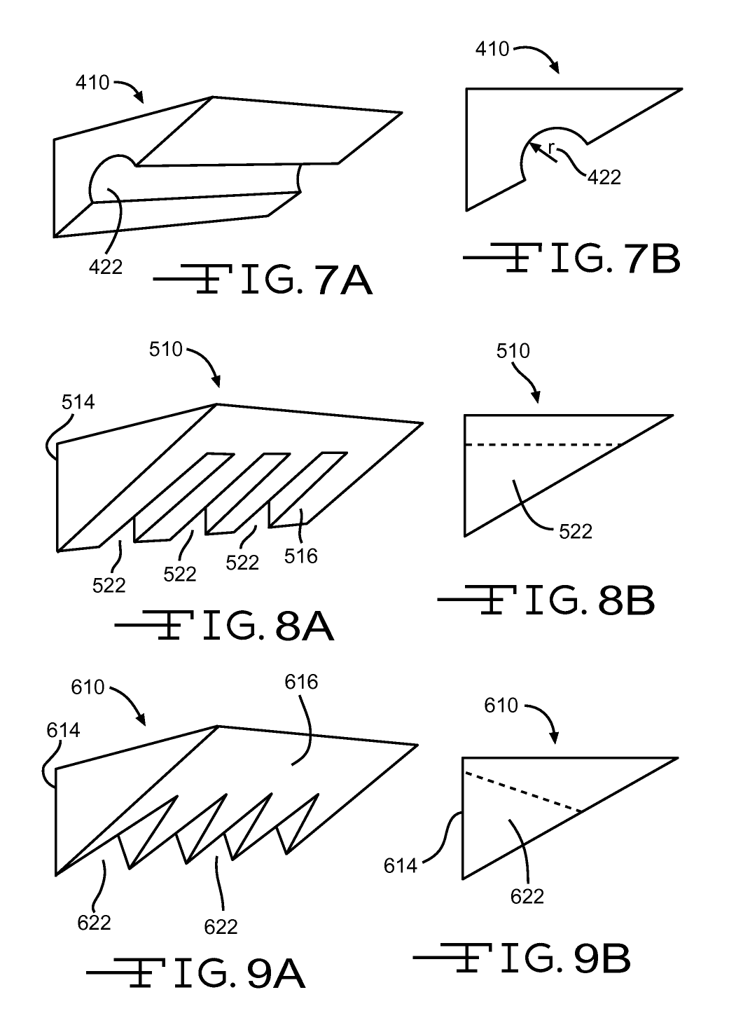

While the embodiment of the gutter insert 310 shown in FIGS. 6A and 6B illustrates a cutout 322 having an angular cross-sectional shape, it should be appreciated that other embodiments of a gutter insert can provide cutouts having other cross-sectional shapes. Referring now to FIGS. 7A and 7B, a fifth embodiment of a gutter insert 410 is illustrated. The gutter insert 410 is the same as, or similar to the gutter insert 310 discussed above and illustrated in FIGS. 6A and 6B, with the exception that a cutout 422 has a semi-circular cross-sectional shape. Referring now to FIG. 7B, the cutout 422 has a radius R. The radius R can be any desired dimension.

Referring now to FIGS. 8A and 8B, a sixth embodiment of a gutter insert is shown generally at 510. The gutter insert 510 is generally the same as, or similar to, the gutter insert 10 described above and illustrated in FIGS. 1 and 2 with the exception that the spaced apart cutouts 522, extending in a generally horizontal direction from a diagonal face 516 of the gutter insert 510 to a back face 514 of the gutter insert 510, have a generally horizontal cross-sectional shape. However, as discussed above, the cutouts 522 can have other desired cross-sectional shapes.

One example of an alternate cutout shape is shown in FIGS. 9A and 9B in the seventh embodiment of a gutter insert 610. In this embodiment, the cutouts 622 have a triangular cross-sectional shape. The cutouts 622 further extend in a generally upward direction from a diagonal face 616 of the gutter insert 610 to the back face 614 of the gutter insert 610.

While the cutouts 622 are shown in FIGS. 9A and 9B as being contiguous, it should be appreciated that alternative embodiments of the gutter insert 610 can arrange the cutouts 622 to be spaced apart.

The principle and mode of operation of the inserts for roofing gutters have been described in certain embodiments. However, it should be noted that the inserts for roofing gutters may be practiced otherwise than as specifically illustrated and described without departing from its scope.

What is claimed is:

1. A gutter insert for a roofing gutter, the roofing gutter having a rear wall, a bottom wall and a front wall, the gutter insert comprising:
a body having a generally triangular cross-sectional shape formed from a top face, a back face and a diagonal face, the diagonal face forming a diagonal from one end of the top face to one end of the back face; and
a plurality of cutouts originating in the diagonal face and extending into the body;
whereas a void is defined by the diagonal face of the body of the gutter insert and the interior surfaces of the bottom wall and front wall of the roofing gutter; and
whereas the cutouts and the void are configured to facilitate the flow of rain water through the roofing gutter.

2. The gutter insert of claim 1, wherein an angle is formed between the top face and the back face, wherein the angle is approximately 90°.

3. The gutter insert of claim 1, wherein the back face of the body is configured to seat against the rear wall of the roofing gutter and an intersection of the back face and the diagonal face of the gutter insert is seated against the intersection of the rear wall and bottom wall of the roofing gutter.

4. The gutter insert of claim 1, wherein the cutouts extend from the diagonal face to the back face.

5. The gutter insert of claim 1, wherein the body is made of open cell polymeric foam.

6. The gutter insert of claim 5, wherein the open cell polymeric foam has a pore size in a range of from about 5.0 pores per inch to about 14.0 pores per inch.

7. The gutter insert of claim 5, wherein the open cell polymeric foam has a density in a range of from about 1.4 pounds per cubic foot to about 1.8 pounds per cubic foot.

8. The gutter insert of claim 5, wherein the open cell polymeric foam has tensile strength in a range of from about 5.0 pounds per square inch to about 8.0 pounds per square inch.

9. The gutter insert of claim 1, wherein the cutouts have a parabolic shape.

10. The gutter insert of claim 9, wherein the cutouts have a width in a range of from about 1.5 inches to about 5.0 inches and a height in a range of from about ⅓ to about ½ of the width of the cutout.

11. The gutter insert of claim 1, wherein each of the cutouts extend into the body of the gutter insert a same distance.

12. The gutter insert of claim 1, wherein the body of the gutter insert includes a fire resistant coating, an algae resistant coating or an ultra-violet light inhibiting coating.

13. The gutter insert of claim 5, wherein the polymeric material includes a fire resistant additive, an algae resistant additive or an ultra-violet light inhibiting additive or combinations thereof.

14. A method of forming a gutter insert for a roofing gutter, the roofing gutter having a rear wall, a bottom wall and a front wall, the method comprising the steps of:
forming a body having a generally triangular cross-sectional shape formed from a top face, a back face and a diagonal face, the diagonal face forming a diagonal from one end of the top face to one end of the back face; and
forming a plurality of cutouts in the body, wherein the plurality of cutouts originate in the diagonal face of the body and extend into the body;
whereas the diagonal formed by the diagonal face of the body defines a void between the diagonal face and the interior surfaces of the bottom wall and front wall of the roofing gutter; and
whereas the cutouts and the void are configured to facilitate the flow of rain water through the roofing gutter.

15. The method of claim 14, wherein the back face of the body is configured to seat against the rear wall of the roofing gutter and an intersection of the back face and the diagonal face of the gutter insert is seated against the intersection of the rear wall and bottom wall of the roofing gutter.

16. The method of claim 14, wherein the cutouts extend from the diagonal face to the back face.

17. The method of claim 14, wherein the gutter insert is made from an open cell polymeric material having a pore size in a range of from about 5.0 pores per inch to about 14.0 pores per inch.

18. The method of claim 14, wherein the cutouts have a parabolic shape.

19. The method of claim 14, wherein the body of the gutter insert includes a fire resistant coating, an algae resistant coating or an ultra-violet light inhibiting coating.

20. The method of claim 17, wherein the polymeric material includes a fire resistant additive, an algae resistant additive or an ultra-violet light inhibiting additive.

21. The gutter insert of claim 17, wherein the open cell polymeric foam has a density in a range of from about 1.4 pounds per cubic foot to about 1.8 pounds per cubic foot.

22. The method of claim 17, wherein the open cell polymeric foam has tensile strength in a range of from about 5.0 pounds per square inch to about 8.0 pounds per square inch.

23. The method of claim 14, wherein the cutouts have a width in a range of from about 1.5 inches to about 5.0 inches and a height in a range of from about ⅓ to about ½ of the width of the cutout.
